(19) United States
(12) Patent Application Publication
(10) Pub. No.: US 2025/0170765 A1
(43) Pub. Date: May 29, 2025

(54) Plasticizing Device, Injection Molding Device, And Three-Dimensional Shaping Device

(71) Applicant: SEIKO EPSON CORPORATION, Tokyo (JP)

(72) Inventor: Asami URAMOTO, Shiojiri (JP)

(21) Appl. No.: 18/956,222

(22) Filed: Nov. 22, 2024

(30) Foreign Application Priority Data
Nov. 24, 2023 (JP) 2023-199013

(51) Int. Cl. B29C 45/60; B29C 64/209; B33Y 30/00

(52) U.S. Cl. CPC B29C 45/60; B29C 64/209; B33Y 30/00

(57) ABSTRACT

A plasticizing device includes: a screw that is rotated about a rotation axis; a barrel that is formed with a communication hole into which a plasticized material obtained by plasticizing a material flows; a heater configured to heat the material; and a screw case that is formed with a recessed portion, and is formed with a supply port for supplying the material to the groove. A length of the screw in a direction along the rotation axis is smaller than a length in a direction perpendicular to the rotation axis, an introduction port is formed in a part of a side surface of the screw, a length of the introduction port is larger than a length of the supply port in the direction along the rotation axis, and a distance between the side surface and an inner wall of the recessed portion varies in a rotation direction of the screw.

The present application is based on, and claims priority from JP Application Serial Number 2023-199013, filed Nov. 24, 2023, the disclosure of which is hereby incorporated by reference herein in its entirety.

### BACKGROUND

### 1. Technical Field

The present disclosure relates to a plasticizing device, an injection molding device, and a three-dimensional shaping device.

### 2. Related Art

It is known an injection molding device that injects a material plasticized by a plasticizing device toward a cavity and molds a molded product by curing the material.

For example, JP-A-2010-241016 discloses a plasticizing and feeding device including a barrel in which a material inflow passage opens at one end surface, a rotor having an end surface that is in sliding contact with the one end surface of the barrel, a spiral groove formed on the end surface of the rotor and communicating with an opening end of the material inflow passage of the barrel, and a casing that accommodates the rotor.

JP-A-2010-241016 is an example of the related art.

In the plasticizing and feeding device having the rotor as described above, a material enters a gap between a side surface of the rotor and the casing and is crushed, and stable plasticization cannot be performed in some cases.

### SUMMARY

A plasticizing device according to a first aspect of the present disclosure includes:
a motor;
a screw that has a groove formation surface in which a spiral groove is formed and is rotated about a rotation axis by the motor;
a barrel that has a facing surface facing the groove formation surface in a direction along the rotation axis and is formed with a communication hole into which a plasticized material obtained by plasticizing a material flows;
a heater configured to heat the material supplied between the groove formation surface and the facing surface; and
a screw case that is formed with a recessed portion, accommodates the screw in the recessed portion, and is formed with a supply port for supplying the material to the groove, in which
a length of the screw in the direction along the rotation axis is smaller than a length in a direction perpendicular to the rotation axis,
an introduction port that is continuous with the groove is formed in a part of a side surface of the screw that intersects the groove formation surface,
a length of the introduction port is larger than a length of the supply port in the direction along the rotation axis, and
a distance between the side surface and an inner wall of the recessed portion varies in a rotation direction of the screw when viewed from the direction along the rotation axis.

An injection molding device according to a second aspect of the present disclosure includes:
the plasticizing device according to the first aspect; and
a nozzle configured to inject the plasticized material into a mold.

A three-dimensional shaping device according to a third aspect of the present disclosure includes:
the plasticizing device according to the first aspect; and
a nozzle configured to discharge the plasticized material toward a stage.

### BRIEF DESCRIPTION OF THE DRAWINGS

FIG. 1 is a side view schematically showing an injection molding device according to an embodiment.

FIG. 2 is a cross-sectional view schematically showing the injection molding device according to the embodiment.

FIG. 3 is a perspective view schematically showing a flat screw of the injection molding device according to the embodiment.

FIG. 4 is a view schematically showing a barrel of the injection molding device according to the embodiment.

FIG. 5 is a view schematically showing the flat screw of the injection molding device according to the embodiment.

FIG. 6 is a view schematically showing the flat screw of the injection molding device according to the embodiment.

FIG. 7 is a cross-sectional view schematically showing the injection molding device according to the embodiment.

FIG. 8 is a cross-sectional view schematically showing a three-dimensional shaping device according to the embodiment.

### DESCRIPTION OF EMBODIMENTS

Hereinafter, embodiments will be described with reference to the drawings. It should be noted that embodiments to be described below are not intended to limit contents of the present disclosure described in the claims. Further, all configurations to be described below are not necessarily essential elements of the present disclosure.

### 1. Injection Molding Device

### 1.1. Overall Configuration

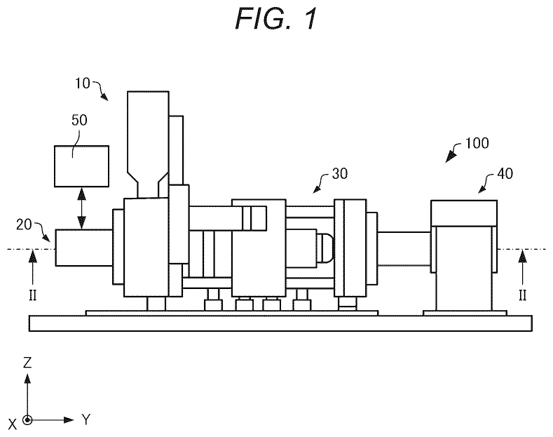

First, an injection molding device according to the embodiment will be described with reference to the drawings. FIG. 1 is a side view schematically showing an injection molding device 100 according to the present embodiment. FIG. 1 shows an X axis, a Y axis, and a Z axis as three axes orthogonal to one another. An X-axis direction and a Y-axis direction are, for example, horizontal directions. A Z-axis direction is, for example, a vertical direction.

As shown in FIG. 1, the injection molding device 100 includes, for example, a material supply unit 10, an injection unit 20, a mold portion 30, a mold clamping unit 40, and a control unit 50.

The material supply unit 10 supplies a material serving as a raw material to the injection unit 20. The material supply unit 10 may be implemented by a hopper. A shape of the material supplied from the material supply unit 10 is, for example, a pellet shape.

The injection unit 20 plasticizes the material supplied from the material supply unit 10 to obtain a plasticized material. The injection unit 20 injects the plasticized material toward the mold portion 30.

The term “plasticize” is a concept including melting and refers to changing from a solid state to a flowable state. Specifically, in a case of a material in which glass transition occurs, the term “plasticize” refers to setting a temperature of the material to a temperature equal to or higher than a glass transition point. In a case of a material in which the glass transition does not occur, the term “plasticize” refers to setting a temperature of the material to a temperature equal to or higher than a melting point.

A cavity corresponding to a shape of a molded product is formed in the mold portion 30. The plasticized material injected from the injection unit 20 flows into the cavity. Then, the plasticized material is cooled and solidified to form a molded product.

The mold clamping unit 40 opens and closes the mold portion 30. The mold clamping unit 40 opens the mold portion 30 after the plasticized material is cooled and solidified. Accordingly, a molded product is discharged to the outside.

The control unit 50 is implemented by, for example, a computer including a processor, a main storage device, and an input and output interface for inputting and outputting signals from and to the outside. The control unit 50 exerts various functions by, for example, executing, by the processor, a program read into the main storage device. Specifically, the control unit 50 controls the injection unit 20 and the mold clamping unit 40. The control unit 50 may be implemented by a combination of a plurality of circuits instead of a computer.

### 1.2. Specific Configuration

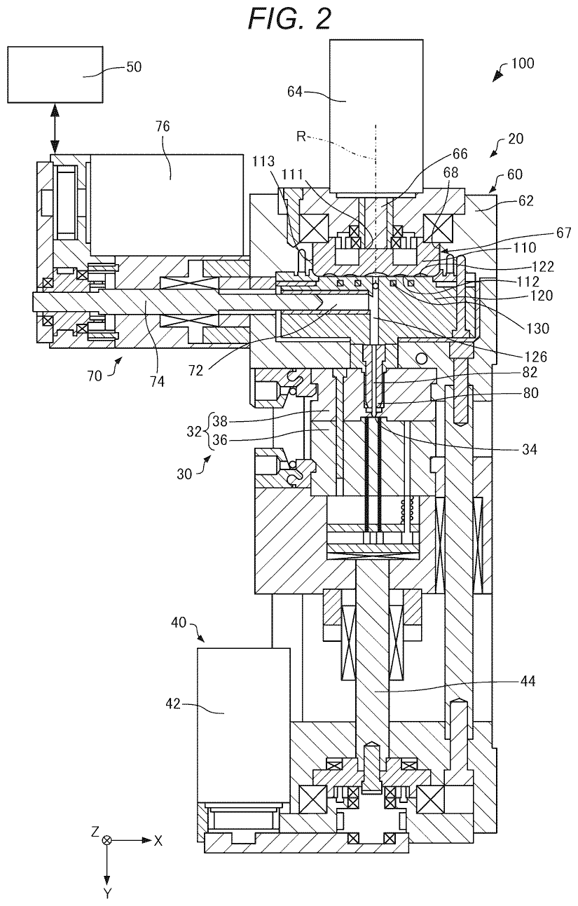

FIG. 2 is a cross-sectional view taken along a line II-II shown in FIG. 1 that schematically shows the injection molding device 100. As shown in FIG. 2, the injection unit 20 includes, for example, a plasticizing device 60, an injection mechanism 70, and a nozzle 80.

The plasticizing device 60 is configured to plasticize at least a part of the material supplied from the material supply unit 10, form a flowable paste-shaped plasticized material, and guide the plasticized material to the injection mechanism 70. The plasticizing device 60 includes, for example, a screw case 62, a drive motor 64, a flat screw 110, a barrel 120, and a heater 130.

The screw case 62 is a housing that accommodates the flat screw 110. The flat screw 110 is accommodated in a space surrounded by the screw case 62 and the barrel 120.

The drive motor 64 is coupled to the screw case 62. The drive motor 64 rotates the flat screw 110. The drive motor 64 is, for example, a servomotor. A shaft 66 of the drive motor 64 is coupled to the flat screw 110. The drive motor 64 is controlled by the control unit 50.

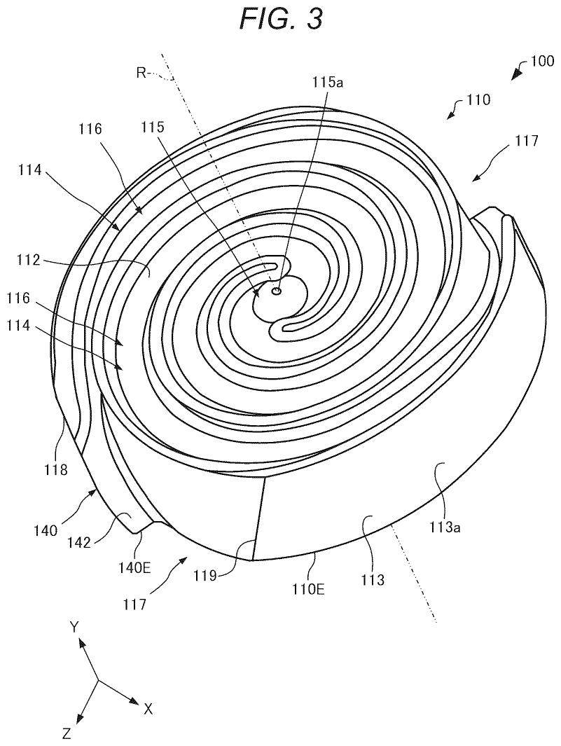

The flat screw 110 has a substantially cylindrical shape in which a size in a direction of a rotation axis R is smaller than a size in a direction orthogonal to the direction of the rotation axis R. In an example shown in the drawing, the rotation axis R is parallel to the Y axis. The flat screw 110 is rotated about the rotation axis R by a torque generated by the drive motor 64. The flat screw 110 has, for example, a shaft surface 111 to which the shaft 66 is coupled, a groove formation surface 112 on an opposite side to the shaft surface 111, and a side surface 113 that couples the shaft surface 111 and the groove formation surface 112. Here, FIG. 3 is a perspective view schematically showing the flat screw 110.

As shown in FIG. 3, first grooves 114 are formed in the groove formation surface 112 of the flat screw 110. The first groove 114 has a spiral shape. The first groove 114 includes, for example, a central portion 115, a coupling portion 116, and an introduction port 117. The central portion 115 faces a communication hole 126 formed in the barrel 120. The central portion 115 communicates with the communication hole 126. The central portion 115 is provided with a protruding portion 115a for efficiently feeding the plasticized material to the communication hole 126. The coupling portion 116 couplings the central portion 115 and the introduction port 117. In the example shown in the drawing, the coupling portion 116 is formed in a spiral shape from the central portion 115 toward an outer periphery of the groove formation surface 112. The introduction port 117 is formed in the outer periphery of the groove formation surface 112. That is, the introduction port 117 is formed in the side surface 113 of the flat screw 110. The material supplied from the material supply unit 10 is introduced from the introduction port 117 into the first groove 114, passes through the coupling portion 116 and the central portion 115, and is conveyed to the communication hole 126 formed in the barrel 120. In the example shown in the drawing, two first grooves 114 are formed.

The number of the first grooves 114 is not particularly limited. Although not shown, three or more first grooves 114 may be formed, or only one first groove 114 may be formed. Details of the flat screw 110 will be described later.

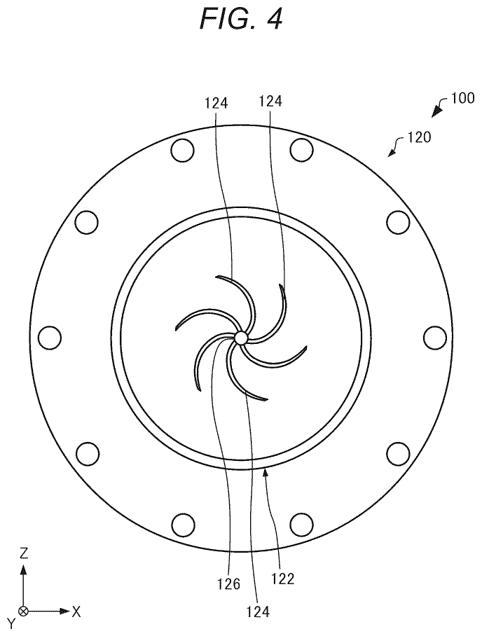

As shown in FIG. 2, the barrel 120 is provided in a manner of facing the flat screw 110. The barrel 120 has a facing surface 122 that faces the groove formation surface 112 of the flat screw 110. The facing surface 122 faces the groove formation surface 112 in the Y-axis direction. The communication hole 126 is formed at the center of the facing surface 122. Here, FIG. 4 is a view schematically showing the barrel 120.

As shown in FIG. 4, second grooves 124 and the communication hole 126 are formed in the facing surface 122 of the barrel 120. A plurality of the second grooves 124 are formed. In the example shown in the drawing, six second grooves 124 are formed, and the number of the second grooves 124 is not particularly limited. The plurality of second grooves 124 are formed around the communication hole 126 when viewed from the Y-axis direction. The second grooves 124 each have one end coupled to the communication hole 126 and extend in a spiral shape from the communication hole 126 toward an outer periphery of the facing surface 122. The second groove 124 has a function of guiding the plasticized material to the communication hole 126. The plasticized material flows into the communication hole 126. The communication hole 126 allows the plasticized material to flow out of the barrel 120.

A shape of the second groove 124 is not particularly limited and may be, for example, a linear shape. The one end of the second groove 124 may not be coupled to the communication hole 126. Further, the second groove 124 may not be formed in the facing surface 122. However, in consideration of efficiently guiding the plasticized material to the communication hole 126, the second groove 124 is preferably formed in the facing surface 122.

As shown in FIG. 2, the heater 130 is provided in the barrel 120. The heater 130 heats the material supplied between the flat screw 110 and the barrel 120. The heater 130 heats the material supplied to the first grooves 114. The heater 130 is controlled by the control unit 50. The plasticizing device 60 forms the plasticized material by heating the material while conveying the material toward the communication hole 126 by the flat screw 110, the barrel 120, and the heater 130, and causes the formed plasticized material to flow out from the communication hole 126 to the injection mechanism 70.

The injection mechanism 70 includes, for example, a cylinder 72, a plunger 74, and a plunger drive unit 76. The cylinder 72 is a substantially cylindrical member coupled to the communication hole 126. The plunger 74 moves inside the cylinder 72. The plunger 74 is driven by the plunger drive unit 76 implemented by a motor, a gear, and the like. The plunger drive unit 76 is controlled by the control unit 50. The cylinder 72 may be coupled to a flow path downstream of the communication hole 126.

The injection mechanism 70 executes a metering operation and an injection operation by sliding the plunger 74 in the cylinder 72. The metering operation refers to an operation of guiding the plasticized material positioned in the communication hole 126 into the cylinder 72 by moving the plunger 74 in the −X-axis direction away from the communication hole 126 and metering the plasticized material in the cylinder 72. The injection operation refers to an operation of injecting the plasticized material in the cylinder 72 into the mold portion 30 through the nozzle 80 by moving the plunger 74 in the +X-axis direction approaching the communication hole 126.

A nozzle hole 82 communicating with the communication hole 126 is formed in the nozzle 80. The nozzle 80 injects the plasticized material supplied from the plasticizing device 60 into a mold 32 of the mold portion 30. Specifically, the plasticized material metered in the cylinder 72 is sent from the injection mechanism 70 to the nozzle hole 82 through the communication hole 126 by executing the metering operation and the injection operation described above. The plasticized material is injected from the nozzle hole 82 into the mold portion 30.

The mold portion 30 includes the mold 32. The plasticized material sent to the nozzle hole 82 is injected from the nozzle hole 82 into a cavity 34 of the mold 32. Specifically, the mold 32 includes a movable mold 36 and a fixed mold 38 facing each other, and has the cavity 34 between the movable mold 36 and the fixed mold 38. The cavity 34 is a space corresponding to a shape of a molded product. Materials of the movable mold 36 and the fixed mold 38 are metal. The materials of the movable mold 36 and the fixed mold 38 may be ceramic or resin.

The mold clamping unit 40 includes, for example, a mold drive unit 42 and a ball screw unit 44. The mold drive unit 42 is implemented by, for example, a motor or a gear. The mold drive unit 42 is coupled to the movable mold 36 via the ball screw unit 44. The mold drive unit 42 is controlled by the control unit 50. The ball screw unit 44 transmits power generated by the driving of the mold drive unit 42 to the movable mold 36. The mold clamping unit 40 opens and closes the mold portion 30 by moving the movable mold 36 by the mold drive unit 42 and the ball screw unit 44.

### 1.3. Flat Screw

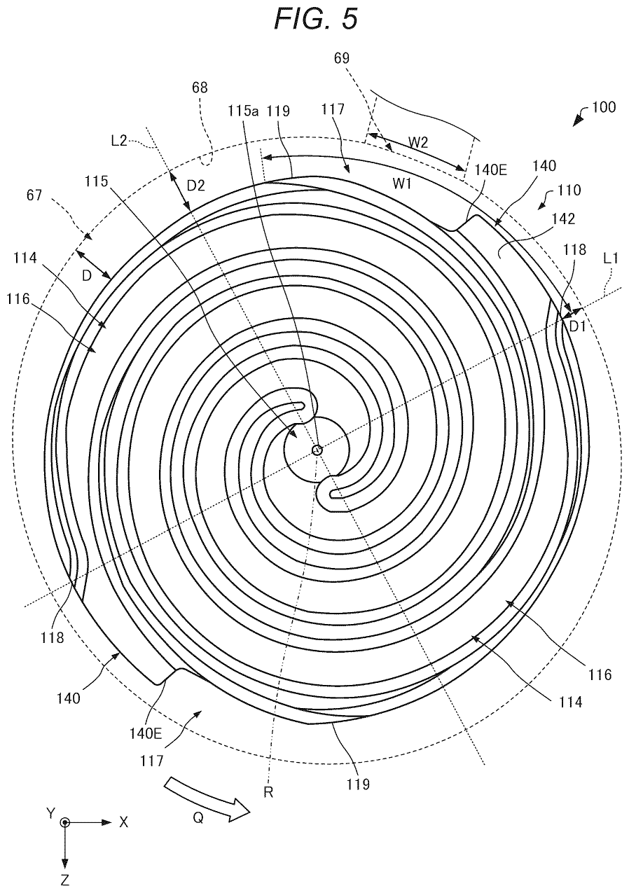

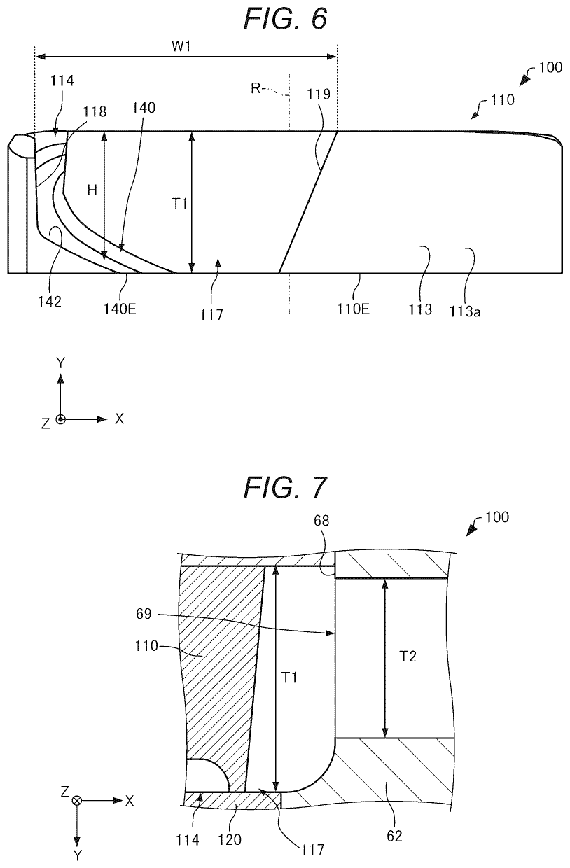

FIGS. 5 and 6 are views schematically showing the flat screw 110. FIG. 7 is a cross-sectional view showing the vicinity of a supply port 69 formed in the screw case 62. Specifically, FIG. 5 is a view taken as viewed from a direction along the rotation axis R. In an example shown in the drawing, the direction along the rotation axis R is the Y-axis direction. FIG. 6 is a view taken as viewed from a direction perpendicular to the rotation axis R.

As shown in FIGS. 3, 5, and 6, a length of the flat screw 110 in the Y-axis direction is smaller than a length in the direction perpendicular to the rotation axis R.

The introduction port 117 that is continuous with the first groove 114 is formed in a part of the side surface 113 of the flat screw 110. The introduction port 117 is an opening extending from a first side 118 to a second side 119 that define the introduction port 117 in a rotation direction Q of the flat screw 110. The first side 118 is located behind the second side 119 in the rotation direction Q. In the example shown in the drawing, a length of the first side 118 is smaller than a length of the second side 119.

The flat screw 110 may have an elliptical shape when viewed in the Y-axis direction. As shown in FIG. 5, a first virtual straight line L1 may be a major axis of an ellipse. The first virtual straight line L1 is a straight line passing through the first side 118 of one of the two first grooves 114 and the first side 118 of the other first groove 114. A second virtual straight line L2 may be a short axis of the ellipse. The second virtual straight line is a straight line that is orthogonal to the first virtual straight line L1 and passes through a midpoint between the two first sides 118.

The first groove 114 has, for example, an introduction groove 140. As shown in FIG. 6, when viewed in the direction perpendicular to the rotation axis R, the introduction groove 140 is located between the first side 118 and the second side 119. The introduction groove 140 becomes deeper from the first side 118 toward the second side 119. That is, a depth H of the introduction groove 140 increases from the first side 118 toward the second side 119. A bottom surface 142 of the introduction groove 140 is inclined such that the depth H increases from the first side 118 toward the second side 119.

An end 140E of the introduction groove 140 is located at an end 110E of the flat screw 110. The end 140E is an end of the introduction groove 140 close to the second side 119. The end 110E is an end of the flat screw 110 in the-Y-axis direction. The end 140E of the introduction groove 140 is located between the first side 118 and the second side 119 when viewed from a direction perpendicular to the Y axis.

As shown in FIG. 2, a recessed portion 67 is formed in the screw case 62. The screw case 62 accommodates the flat screw 110 in the recessed portion 67.

As shown in FIG. 7, the supply port 69 is formed in an inner wall 68 of the recessed portion 67. The supply port 69 supplies a material to the first groove 114. The inner wall 68 is a surface of the screw case 62 that defines the recessed portion 67. For convenience, in FIG. 5, the inner wall 68 of the recessed portion 67 and the supply port 69 formed in the inner wall 68 are indicated by broken lines. The inner wall 68 has, for example, a circular shape. The center of the circle is, for example, an intersection of the first virtual straight line L1 and the second virtual straight line L2.

When viewed in the Y-axis direction, a distance D between the side surface 113 of the flat screw 110 and the inner wall 68 varies in the rotation direction Q. The distance D is a distance between the inner wall 68 and a region 113a of the side surface 113 where the introduction port 117 is not formed. The first side 118 and the second side 119 are boundary lines between the introduction port 117 and the region 113a. The side surface 113 intersects the groove formation surface 112. The side surface 113 is, for example, orthogonal to the groove formation surface 112.

For example, the distance D is shortest at the first side 118. In other words, the distance D is shortest between the first side 118 and the inner wall 68. The distance D is shortest on the first virtual straight line L1. In FIG. 5, the shortest length of the distance D is indicated by D1. The distance D may be shortest at the end 140E of the introduction groove 140. The distance D is, for example, longest on the second virtual straight line L2. In FIG. 5, the longest length of the distance D is indicated by D2.

The shortest length D1 of the distance D is, for example, smaller than a length of the material. The longest length D2 of the distance D is, for example, larger than the length of the material. The “length of the material” refers to an average of maximum lengths of the pellet-shaped material. The maximum length of the pellet-shaped material is obtained, for example, by imaging a plurality of materials using an imaging unit attached to a metal microscope and calculating an average value of the plurality of materials based on the image.

In the rotation direction Q, for example, a length W1 of the introduction port 117 is larger than a length W2 of the supply port 69. The length W1 is a maximum dimension of the introduction port 117 in the direction of the rotation axis R. The length W2 is a maximum dimension of the supply port 69 in the rotation direction Q. In the Y-axis direction, for example, a length T1 of the introduction port 117 is larger than a length T2 of the supply port 69. The length T1 is a maximum dimension of the introduction port 117 in the Y-axis direction. The length T2 is a maximum dimension of the supply port 69 in the Y-axis direction.

Although not shown, when the distance D varies in the rotation direction Q, the flat screw 110 may have a circular shape and the inner wall 68 may have an elliptical shape as viewed from the Y-axis direction.

### 1.4. Functions and Advantages

In the plasticizing device 60, a length of the flat screw 110 in the direction along the rotation axis R is smaller than a length in the direction perpendicular to the rotation axis R. The introduction port 117 that is continuous with the first groove 114 is formed in a part of the side surface 113 of the flat screw 110 that intersects the groove formation surface 112. In the direction along the rotation axis R, the length W1 of the introduction port 117 is larger than the length W2 of the supply port 69. When viewed in the direction along the rotation axis R, the distance D between the side surface 113 and the inner wall 68 of the recessed portion 67 varies in the rotation direction Q of the flat screw 110.

Therefore, in the plasticizing device 60, the flat screw 110 can scrape the material into the introduction port 117 at a portion where the distance D is short, and can prevent the material from being crushed at a portion where the distance D is long. Accordingly, the material can be stably plasticized. For example, the material rolling on the portion of the flat screw 110 where the distance D is long can be scraped at the portion of the flat screw 110 where the distance D is short. For example, when the material is crushed, the crushed material may go around to an angular bearing of the plasticizing device, which may cause damage.

In the plasticizing device 60, the introduction port 117 is an opening extending from the first side 118 to the second side 119 that define the introduction port 117 in the rotation direction Q of the flat screw 110, the first side 118 is located behind the second side 119 in the rotation direction Q, and the distance D is shortest at the first side 118. Therefore, in the plasticizing device 60, the material between the side surface 113 of the flat screw 110 and the inner wall 68 can be scraped into the introduction port 117 at the first side 118 of the flat screw 110.

In the plasticizing device 60, the first groove 114 has the introduction groove 140 located between the first side 118 and the second side 119 when viewed from the direction perpendicular to the rotation axis R, and the introduction groove 140 becomes deeper from the first side 118 toward the second side 119. Therefore, in the plasticizing device 60, the material is easily conveyed to the central portion 115 of the first groove 114.

In the plasticizing device 60, the end 140E of the introduction groove 140 is located between the first side 118 and the second side 119 when viewed from the direction perpendicular to the rotation axis R. Therefore, in the plasticizing device 60, the material is easily conveyed to the central portion 115 of the first groove 114.

In the plasticizing device 60, the end 140E of the introduction groove 140 is located at the end 110E in the direction along the rotation axis R of the flat screw 110. Therefore, in the plasticizing device 60, the material can be conveyed to the central portion 115 of the first groove 114 without any overflow.

In the plasticizing device 60, the material has a pellet shape, the shortest length D1 of the distance D is smaller than a size of the material, and the longest length D2 of the distance D is larger than the size of the material. Therefore, in the plasticizing device 60, the material can be scraped at the portion where the distance D is shortest, and the material can be prevented from being crushed at the portion where the distance D is longest.

In the plasticizing device 60, the length W1 of the introduction port 117 is larger than the length W2 of the supply port 69 in the rotation direction Q. Therefore, the plasticizing device 60 easily conveys the material to the first groove 114.

### 2. Three-Dimensional Shaping Device

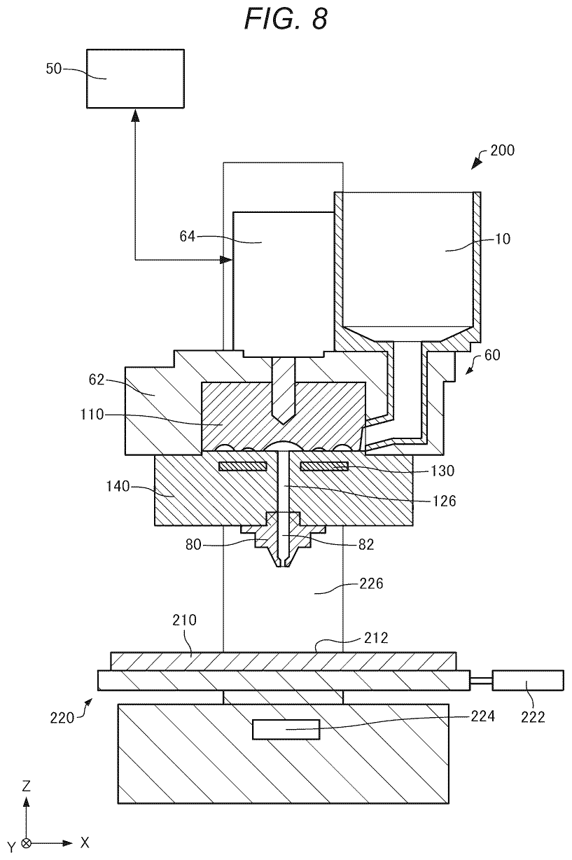

Next, a three-dimensional shaping device according to the embodiment will be described with reference to the drawing. FIG. 8 is a cross-sectional view schematically showing a three-dimensional shaping device 200 according to the present embodiment.

For example, as shown in FIG. 8, the three-dimensional shaping device 200 includes the material supply unit 10, the control unit 50, the plasticizing device 60, the nozzle 80, a stage 210, and a position changing unit 220. The three-dimensional shaping device 200 is a three-dimensional shaping device of fused deposition modeling (FDM) (registered trademark) type. For convenience, in FIG. 8, the plasticizing device 60 is shown in a simplified manner.

The nozzle 80 discharges the plasticized material supplied from the plasticizing device 60 toward the stage 210. Specifically, the three-dimensional shaping device 200 changes relative positions between the nozzle 80 and the stage 210 by driving the position changing unit 220 while discharging the plasticized material from the nozzle 80 to the stage 210. Accordingly, the three-dimensional shaping device 200 shapes a three-dimensional shaped object having a desired shape on the stage 210.

The stage 210 is provided below the nozzle 80. In the example shown in the drawing, the stage 210 has a rectangular parallelepiped shape. The stage 210 supports the plasticized material discharged from the nozzle 80. The stage has a stacking surface 212 on which the plasticized material is stacked.

A material of the stage 210 is, for example, a metal such as aluminum. The stage 210 may be formed of a metal plate and an adhesive sheet provided on the metal plate. In this case, the stacking surface 212 is formed by the adhesive sheet. The adhesive sheet can improve adhesion between the stage 210 and the plasticized material discharged from the nozzle 80.

Although not shown, the stage 210 may be formed of a metal plate in which a groove is formed, and an underlayer provided to fill the groove. In this case, the stacking surface 212 is formed by the underlayer. A material of the underlayer is, for example, the same as that of the plasticized material. The underlayer can improve adhesion between the stage 210 and the plasticized material discharged from the nozzle 80.

The position changing unit 220 supports the stage 210. The position changing unit 220 changes relative positions between the nozzle 80 and the stage 210. In the example shown in the drawing, the position changing unit 220 changes the relative positions between the nozzle 80 and the stage 210 in the X-axis direction and the Y-axis direction by moving the stage 210 in the X-axis direction and the Y-axis direction. Further, the position changing unit 220 changes the relative positions between the nozzle 80 and the stage 210 in the Z-axis direction by moving the nozzle 80 in the Z-axis direction.

The position changing unit 220 includes, for example, a first electric actuator 222, a second electric actuator 224, and a third electric actuator 226. The first electric actuator 222 moves the stage 210 in the X-axis direction. The second electric actuator 224 moves the stage 210 in the Y-axis direction. The third electric actuator 226 moves the nozzle 80 in the Z-axis direction. The third electric actuator 226 supports, for example, the screw case 62 of the plasticizing device 60.

A configuration of the position changing unit 220 is not particularly limited as long as the position changing unit 220 can change the relative positions between the nozzle 80 and the stage 210. For example, the position changing unit 220 may move the stage 210 in the Z-axis direction and move the nozzle 80 in the X-axis direction and the Y-axis direction, or may move the stage 210 or the nozzle 80 in the X-axis direction, the Y-axis direction, and the Z-axis direction.

### 3. Modification of Material

In the above description, an example is described in which the material supplied from the material supply unit 10 is an elastomer. On the other hand, the material supplied from the material supply unit 10 may be a material other than the elastomer, or a material obtained by adding another component to the elastomer.

The material supplied from the material supply unit 10 is, for example, various materials including a thermoplastic material, a metal material, and a ceramic material as a main material. Here, the “main material” refers to a material serving as a core material for forming a shape of a molded product molded by the injection molding device 100, and refers to a material having a content of 50% by mass or more in a molded product. The material described above includes a material obtained by melting the main material alone and a material obtained by melting the main material and a part of contained components into a paste shape.

Examples of the thermoplastic material include a thermoplastic resin. Examples of the thermoplastic resin include acrylonitrile butadiene styrene (ABS) resin, polyethylene (PE), polypropylene (PP), polyethylene terephthalate (PET), and polyvinyl chloride (PVC).

The thermoplastic resin may be general-purpose engineering plastics. Examples of the general-purpose engineering plastic include polyacetal (POM), polyamide (PA), polylactic acid (PLA), polyphenylene sulfide (PPS), polycarbonate (PC), and modified polyphenylene ether (m-PPE).

The thermoplastic resin may be super engineering plastic. Examples of the super engineering plastic include polysulfone (PSU), polyethersulfone (PES), polyphenylene sulfide (PPS), polyarylate (PAR), polyimide (PI), polyamideimide (PAI), polyetherimide (PEI), and polyether ether ketone (PEEK).

In addition to pigment, metal, and ceramic, additives such as wax, flame retardant, antioxidant, and heat stabilizer may be mixed into the thermoplastic material. In the plasticizing device 60, the thermoplastic material is plasticized and converted into a molten state by rotation of the flat screw 110 and heating of the heater 130. The plasticized material formed in this manner is stacked from the nozzle 80, and then is cured due to a decrease in temperature. It is desirable that the thermoplastic material is discharged from the nozzle 80 in a completely molten state by being heated to a temperature of the glass transition point or higher.

In the plasticizing device 60, for example, a metal material may be used as a main material instead of the above-described thermoplastic material. In this case, it is desirable that a powder material obtained by powdering the metal material is mixed with a component that is melted when the plasticized material is formed, and the mixture is fed into the plasticizing device 60.

Examples of the metal material include a single metal such as magnesium (Mg), iron (Fe), cobalt (Co), chromium (Cr), aluminum (Al), titanium (Ti), copper (Cu), and nickel (Ni), or an alloy containing one or more of these metals, maraging steel, stainless steel, cobalt chromium molybdenum, a titanium alloy, a nickel alloy, an aluminum alloy, a cobalt alloy, and a cobalt chromium alloy.

In the plasticizing device 60, a ceramic material may be used as the main material instead of the above-described metal material. Examples of the ceramic material include oxide ceramic such as silicon dioxide, titanium dioxide, aluminum oxide, and zirconium oxide, and non-oxide ceramic such as aluminum nitride.

A powder material of the metal material or the ceramic material supplied from the material supply unit 10 may be a mixed material obtained by mixing a plurality of types of powder of the single metal, powder of the alloy, or powder of the ceramic material. The powder material of the metal material or the ceramic material may be coated with, for example, the thermoplastic resin described above or another thermoplastic resin. In this case, in the plasticizing device 60, the thermoplastic resin coated with the powder material may melt to develop fluidity.

For example, a solvent may be added to the powder material of the metal material or the ceramic material supplied from the material supply unit 10. Examples of the solvent include: water; (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetylacetone; alcohols such as ethanol, propanol, and butanol; tetraalkylammonium acetates; sulfoxide-based solvents such as dimethyl sulfoxide and diethyl sulfoxide; pyridine-based solvents such as pyridine, γ-picoline, and 2,6-lutidine; tetraalkylammonium acetates (for example, tetrabutylammonium acetate); and ionic liquids such as butyl carbitol acetate.

In addition, for example, a binder may be added to the powder material of the metal material or the ceramic material supplied from the material supply unit 10. Examples of the binder include acrylic resin, epoxy resin, silicone resin, cellulose-based resin, other synthetic resin, PLA, PA, PPS, PEEK, and other thermoplastic resin.

The embodiment and the modifications described above are examples, and the present disclosure is not limited thereto. For example, the embodiment and the modifications may be combined as appropriate.

The present disclosure includes substantially the same configurations as the configurations described in the embodiment, such as a configuration having the same function, method, and result and a configuration having the same object and effect. The present disclosure includes a configuration in which a non-essential portion of the configuration described in the embodiments is replaced. The present disclosure includes a configuration capable of achieving the same function and effect or a configuration capable of achieving the same object as the configuration described in the embodiments. The present disclosure includes a configuration obtained by adding a known technique to the configuration described in the embodiments.

The following contents are derived from the embodiment and the modifications described above.

In a first aspect, a plasticizing device includes:
a motor;
a screw that has a groove formation surface in which a spiral groove is formed and is rotated about a rotation axis by the motor;
a barrel that has a facing surface facing the groove formation surface in a direction along the rotation axis and is formed with a communication hole into which a plasticized material obtained by plasticizing a material flows;
a heater configured to heat the material supplied between the groove formation surface and the facing surface; and
a screw case that is formed with a recessed portion, accommodates the screw in the recessed portion, and is formed with a supply port for supplying the material to the groove, in which
a length of the screw in the direction along the rotation axis is smaller than a length in a direction perpendicular to the rotation axis,
an introduction port that is continuous with the groove is formed in a part of a side surface of the screw that intersects the groove formation surface,
a length of the introduction port is larger than a length of the supply port in the direction along the rotation axis, and
a distance between the side surface and an inner wall of the recessed portion varies in a rotation direction of the screw when viewed from the direction along the rotation axis.

According to the plasticizing device, the material can be stably plasticized.

In the plasticizing device according to the first aspect,
the introduction port may be an opening extending from a first side to a second side that define the introduction port in the rotation direction,
the first side may be located behind the second side in the rotation direction, and
the distance may be shortest on the first side.

According to the plasticizing device, the material between the side surface and the inner wall can be scraped into the introduction port at the first side of the screw.

In the plasticizing device according to the first aspect,
the groove may have an introduction groove located between the first side and the second side when viewed from the direction perpendicular to the rotation axis, and
the introduction groove may become deeper from the first side toward the second side.

According to the plasticizing device, the material is easily conveyed to a central portion of the groove.

In the plasticizing device according to the first aspect, an end of the introduction groove may be located between the first side and the second side when viewed from the direction perpendicular to the rotation axis.

According to the plasticizing device, the material is easily conveyed to the central portion of the groove.

In the plasticizing device according to the first aspect, the end of the introduction groove may be located at an end of the screw in the direction along the rotation axis.

According to the plasticizing device, the material can be conveyed to the central portion of the groove without any overflow.

In the plasticizing device according to the first aspect,
the material may have a pellet shape,
a shortest length of the distance may be smaller than a length of the material, and
a longest length of the distance may be larger than the length of the material.

According to the plasticizing device, the material can be scraped at a portion where the distance is shortest, and the material can be prevented from being crushed at a portion where the distance is longest.

In the plasticizing device according to the first aspect, a length of the introduction port may be larger than a length of the supply port in the rotation direction.

According to this plasticizing device, the material is easily conveyed to the groove.

An injection molding device according to a second aspect includes:
the plasticizing device according to the first aspect; and
a nozzle configured to inject the plasticized material into a mold.

A three-dimensional shaping device according to a third aspect includes:
the plasticizing device according to the first aspect; and
a nozzle configured to discharge the plasticized material toward a stage.

What is claimed is:

1. A plasticizing device comprising:
a motor;
a screw that has a groove formation surface in which a spiral groove is formed and is rotated about a rotation axis by the motor;
a barrel that has a facing surface facing the groove formation surface in a direction along the rotation axis and is formed with a communication hole into which a plasticized material obtained by plasticizing a material flows;
a heater configured to heat the material supplied between the groove formation surface and the facing surface; and
a screw case that is formed with a recessed portion, accommodates the screw in the recessed portion, and is formed with a supply port for supplying the material to the groove, wherein
a length of the screw in the direction along the rotation axis is smaller than a length in a direction perpendicular to the rotation axis,
an introduction port that is continuous with the groove is formed in a part of a side surface of the screw that intersects the groove formation surface,
a length of the introduction port is larger than a length of the supply port in the direction along the rotation axis, and
a distance between the side surface and an inner wall of the recessed portion varies in a rotation direction of the screw when viewed from the direction along the rotation axis.

2. The plasticizing device according to claim 1, wherein
the introduction port is an opening extending from a first side to a second side that define the introduction port in the rotation direction,
the first side is located behind the second side in the rotation direction, and
the distance is shortest on the first side.

3. The plasticizing device according to claim 2, wherein
the groove has an introduction groove located between the first side and the second side when viewed from the direction perpendicular to the rotation axis, and
the introduction groove becomes deeper from the first side toward the second side.

4. The plasticizing device according to claim 3, wherein
an end of the introduction groove is located between the first side and the second side when viewed from the direction perpendicular to the rotation axis.

5. The plasticizing device according to claim 3, wherein
the end of the introduction groove is located at an end of the screw in the direction along the rotation axis.

6. The plasticizing device according to claim 1, wherein
the material has a pellet shape,
a shortest length of the distance is smaller than a length of the material, and
a longest length of the distance is larger than the length of the material.

7. The plasticizing device according to claim 1, wherein
a length of the introduction port is larger than a length of the supply port in the rotation direction.

8. An injection molding device comprising:
the plasticizing device according to claim 1; and
a nozzle configured to inject the plasticized material into a mold.

9. A three-dimensional shaping device comprising:
the plasticizing device according to claim 1; and
a nozzle configured to discharge the plasticized material toward a stage.
